(19) United States
(12) Patent Application Publication
(10) Pub. No.: US 2016/0376176 A1
(43) Pub. Date: Dec. 29, 2016

(54) Aerobic Wastewater Treatment Package With Extended Aeration - Activated Sludge

(71) Applicant: Hady HAMIDYAN, Sadeghieh Sq., Tehran (IR)

(72) Inventor: Hady Hamidyan, Tehran (IR)

(21) Appl. No.: 15/038,308

(22) PCT Filed: Mar. 8, 2014
(86) PCT No.: PCT/IB2014/059553

§ 371 Date: May 20, 2016

(51) Int. Cl. C02F 3/22; C02F 3/20; C02F 1/76

(52) U.S. Cl. CPC C02F 3/223; C02F 1/76; C02F 3/201; C02F 2303/04

(57) ABSTRACT

The present invention provides for sanitary sewage and industrial waste water pollution through extended aeration and activated sludge and biological treatment. Oxygen guided by suitable blowers, fertile aerobic microorganisms. Within 30 to 40 days, a dense cell mass is responsible for wastewater treatment digestion is formed. Digital timer function with automatic aeration adjusted according to the amount of raw sewage. If you increase or decrease the amount of waste, it can be reset by moving the thorns.

### FIELD OF THE INVENTION

Water and sewer utilities and infrastructure of wastewater treatment by activated sludge

### DESCRIPTION OF THE PRIOR

Improve wastewater treatment methods in order to reduce possible adverse effects to the receiving environment is one of the ways to achieve sustainable development of the environment. In this way, the use of new methods of design and construction and operation of the sewage treatment plant with the aim of increasing performance in the removal of pollutant parameters and reduction of costs of construction and operating should be considered. One of the new ways in which the world is faced with a large reception process is Extended Aeration that 90 to 95% of wastewater treatment and pollution load is reduced. This process is an extended aeration activated sludge system in which a region of upward-flow anaerobic sludge flow combined aerobic microorganisms thus, they fertilized. The performance of the plant is very simple and can be adjusted after the launch itself. The performance of this package so that sewage discharge to surface water is standard, refined, and outgoing effluent can be used for the irrigation of green space and agricultural land, water views and even water fountains. Maintaining health and individual health promotion as one of today's necessities of human communities. Growing industry due to the diverse communities that have been exposed to infection. Water condition is critical and therefore the importance of proper use of that has been clear for human societies from old. Water is converted to water after different use and should provide some strategies to prevent the environment to contamination by wastewater collection. The use of sewage collection systems has been used so far in the world. For example the most important archaeological sites such as Persepolis there are high precision and sewage collection and surface water drainage has been done according to certain principles.

### PROBLEMS FOUND IN PREVIOUS METHODS

A) Often contained packages made of metal and quickly develop rust, corrosion, and if stainless steel is used it is very expensive and is not cost-effective, except of component such as plan SOAF France made of fiberglass, but with aeration surface does that do not have deep aeration efficiency or WPL England Fiberglass and both are large and expensive due to the weight of the package and are not competitive.

B) Chlorination network within the package is very important. The wastewater treatment plant operations must be carried out in two major processes, chemical and physical operations at first second disinfect it to transfer to the environment. In this way, disinfectant must pass retention time served and then enter the environment. Design and built in canal in the upper part of the main package provides this.

C) More often settling effluent directly enters the outlet pipe of package. In this package, half the circumference (model P5 equal to 308 cm) for the overflow effluent settling to chlorination channel and this overflow cause prevents possible effluent from sedimentation. In the other hand, TDS (Total Dissolved Solids) of final output reach to minimum.

D) In the packages in the world, airlift discharged sludge is not anticipated. With regard to the existence of air blower manufacturing aerated, airlift embedded in the bottom of the settling tank, drain out excess sludge, solve produced problems, such as a package car, and dump the sludge and high costs associated.

### SUMMARY OF THE INVENTION

The present invention provides for sanitary sewage and industrial waste water pollution through extended aeration and activated sludge and biological treatment. Oxygen guided by suitable blowers, fertile aerobic microorganisms. Within 30 to 40 days, a dense cell mass is responsible for wastewater treatment digestion is formed. Digital timer function with automatic aeration adjusted according to the amount of raw sewage. If you increase or decrease the amount of waste, it can be reset by moving the thorns. In this regard, it is necessary at first devices is always perfectly aligned second, effluent without any obstacle can easily be removed from the device.

### BRIEF DESCRIPTION OF FIGURE

FIG. 1 is a cross-sectional view of the package.

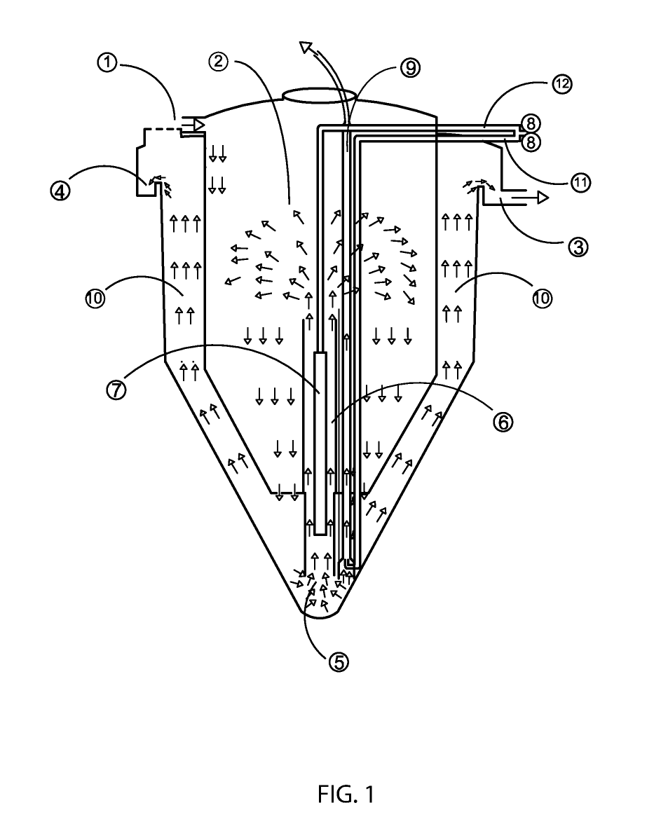

### DESCRIPTION OF INVENTION

The present invention provides for sanitary sewage and industrial waste water pollution through extended aeration and activated sludge and biological treatment. Oxygen guided by suitable blowers, fertile aerobic microorganisms. Within 30 to 40 days, a dense cell mass is responsible for wastewater treatment digestion is formed. Digital timer function with automatic aeration adjusted according to the amount of raw sewage. If you increase or decrease the amount of waste, it can be reset by moving the thorns. In this regard, it is necessary at first devices is always perfectly aligned second, effluent without any obstacle can easily be removed from the device.

The wastewater through inlet pipe 1 enters the air 2 and where the return sludge from the bottom of the settling tank 5 is mixed 2, required air of airlift through the inlet pipe 11 is provided. After this incorporation, After the incorporation, flow from the aeration tank move to settling (clarifier chamber) clarified effluent sludge is then separated into a slow, upward moving through the spillway 10 Drumsticks channel 4 and finally the exit pipe 3. In Chlorinated canals, creating an obstacle course (Baffle) for mixing the effluent with chlorine and provide adequate retention time, disinfection is carried out. Chlorine effluent directed irrigation networks or other methods of disposal. Aerobic bacteria consume more sludge produced and excess sludge can be discharged through sludge airlift 9 out of the package. Required air through two devices or Side Channel Blower 8 via the air inlet pipe 12 into the diffuser tube 7 and from there air as very fine move to conductor pipe 6 and from there goes the aeration 2 after injection to waste water fertilize microorganisms. Each package is equipped a suitable electrical power supply to prevent electrical shock potential fluctuations.

Every one to two years (depending on the amount of raw sewage and pollution), the amount of activated sludge in the settling immediately after turning off the aeration blower, we measured with a graduated cylinder. If the sludge deposited at 1000 cm³ fluid sampled within twenty minutes, is more than 350 cubic centimeters, it is enough the gas valve 1 (40 mm) closed and valve No. 2 (32 mm) opened. In this way, a viscous fluid in bottom of the tank through using embedded airlift packages is removed. The additional sludge is able to dry in the soil and by having organic matter count in the row of high quality fertilizers. What is important is that this package does not need to have a vehicle for discharging sludge.

Feature of this invention can be made as follows:

This invention has Electrical Automatic Programming Board to regulate the pumps operation and aeration as well as two good aeration as standby. Chlorinated effluent from the settling of the network acts as an overflow. Washable, low price, low maintenance costs, as well as relocation package for use in situations of public use that leads to other benefits that even usable for small residential units especially in the beach bar will be high levels of underground water.

Unique Wastewater Treatment Integrate Package
New airlift to drain excess sludge.
Chlorination network.
Deep aeration through air injection diffusers finely.
Minimum space requirement for deployment and installation.
Automatic applicable and does not require constant operator.
Possible to improve the capacity in expansion plans.
Portable and installed by hand.
Very easy operation and low cost maintenance.
Current from sedimentation to chlorination canal act through overflow.
Stainless and anti-corrosion.
Due to special design, no need the back sludge airlift by pump.
Power consumption is very low.
This invention can be used in the following cases:
Townships, residential complexes, commercial and administrative
Hospitals, health centers
Industries, factories, workshop
Recreation centers, educational and military
Terminals, seaports and airports
Hotels, resorts travelers and tourists
Adjacent facilities, dams, rivers and . . . .

1. Patented wastewater treatment package consisting of inverted cone-shaped reservoir that has wastewater input and output in which using cylinder made of membrane surrounded by
a vertical tube membrane oxygen (aeration) is carried out and by using of wastewater overflow system and injecting chlorine, disinfection process takes place and the system can
drain the excess sludge of wastewater treatment to treat wastewater.

2. The invention of claim 1 including a cylindrical tube preferably polyethylene or similar material or even metal.

3. The invention of claim 1 which including a sprayer air-porous tube (made from the membrane) and can inject very tiny air bubbles in the tank at the center of the cylinder mentioned in claim 2.

4. The system of claim 1, by leaving tiny air bubbles between the conductors mentioned in claim 2, causing upward flow of fluid and afterwards the suction of sludge to the top of deposits on floor Hopper.

5. The system of claim 1 when the air bubbles move upward, sludge particles distributed in total volume of the tank like fungal algorithms, causing the collision between the sludge particles, bacteria and air bubbles.

6. The system of sewer overflow in claim 1, creating a horizontal surface in the direction of flow of sewage will cause sludge particles remain on the edge.

7. The overflow sewage system in claim 1 in which the ramps around the reservoir make it possible chlorination and provide chlorine and sewage more exposure.

8. The system of claim 1 in which in the bottom of the chlorination channel (overflow) using the vertical components to suppose sewage to go through the helix way, thereby sewage chlorine exposure time increases as well.

9. The excess sludge discharge system of claim 1 by using bat shape air blowing in the bottom of the exit path of excess sludge, cause sludge move upward and out of the path of the discharge.

10. The method of claim 1, wherein:
a genus of polyethylene Package High Density (HDPE) with a thickness of at least 15 mm by centrifuge kiln constructed as a unified body that can made if necessary from metal, concrete or fiberglass.

11. The method of claim 1, wherein:
a blower through the right diffuser tube does a deep aeration.

12. The method of claim 1, wherein:
a channel of chlorination and effluent will disinfected before entering the environment.

13. The method of claim 1, wherein:
effluent transfer from deposition to chlorination serves as an overflow.

14. The method of claim 1, wherein:
works automatic function and does not require constant operator.

15. The method of claim 1, wherein:
effluent discharge into surface water is in range of international standards limit and does not need false well.

16. The method of claim 1, wherein:
a deposition angle is 60 degrees relative to the horizontal surface and cause maximum sludge thickening and deposition.
